(19) United States
(12) Patent Application Publication
(10) Pub. No.: US 2005/0253987 A1
(43) Pub. Date: Nov. 17, 2005

(54) Reflectance-matching layer for cholesteric display having dye layer and reflective conductors

(75) Inventors: Stanley W. Stephenson III, Spencerport, NY (US); John I. Kilburn, Hilton, NY (US); Terry J. Martin, Rochester, NY (US)

Correspondence Address: Paul A. Leipold;Patent Legal Staff, Eastman Kodak Comapny, 343 State Street, Rochester, NY, 14650-2201, US

(73) Assignee: Eastman Kodak Company

(21) Appl. No.: 10/847,188

(22) Filed: May 17, 2004

(51) Int. Cl. G02F 1/1335

(52) U.S. Cl. 349/113

(57) ABSTRACT

A display sheet comprises in order a substrate, transparent first conductors, a light-modulating material having different first and second field-changeable stable optical states, a light-absorbing layer that absorbs a portion of the visible spectrum and transmits a portion of the visible spectrum, substantially reflective second conductors forming conductive segments that operate in conjunction with the light-absorbing layer to provide reflective light additional to that provided by the light-modulating material, and substantially reflective non-conductive material, disposed over one or more background areas of light-absorbing layer not covered by second conductors, to provide reflective light additional to that provided by the light-modulating material such that the total reflected light in background areas more closely match the total reflected light in the segmented areas when both areas are in the same optical state

### FIELD OF THE INVENTION

The present invention relates to display elements having a light-absorbing layer under a light-modulating layer that allows visible light to be reflected by substantially reflective conductors corresponding to segments in a display.

### BACKGROUND OF THE INVENTION

Currently, information is displayed using assembled sheets of paper carrying permanent inks or displayed on electronically modulated surfaces such as cathode ray displays or liquid crystal displays. Printed information cannot be changed. Electrically updated displays are often heavy and expensive. Other sheet materials can carry magnetically written areas, for example, to carry ticketing or financial information. Such magnetically written data, however, is not visible.

Media systems exist that maintain electronically changeable data without power. Such systems can be electrophoretic (Eink), Gyricon, or polymer dispersed cholesteric materials. An example of such electronically updateable displays can be found in U.S. Pat. No. 3,600,060 issued Aug. 17, 1971 to Churchill et al., which patent shows a device having a coated, then dried emulsion of cholesteric liquid crystals in aqueous gelatin to form a field-responsive, bistable display. U.S. Pat. No. 3,816,786 also to Churchill et al. discloses a layer of encapsulated cholesteric liquid crystal responsive to an electric field. The electrodes in the patent can be transparent or non-transparent and formed of various metals or graphite. It is disclosed that one electrode must be light absorbing, and it is suggested that the light absorbing electrode be prepared from paints containing conductive material such as carbon.

Fabrication of flexible, electronically written display sheets is disclosed in U.S. Pat. No. 4,435,047 issued Mar. 6, 1984 to Fergason. A substrate supports a first conductive electrode, one or more layers of encapsulated liquid crystals, and a second electrode of electrically conductive ink. The conductive inks form a background for absorbing light, so that the information-bearing display areas appear dark in contrast to background non-display areas. Electrical potential applied to opposing conductive areas operates on the liquid crystal material to expose display areas. Because the liquid crystal material is nematic liquid crystal, the display ceases to present an image when de-energized, that is, in the absence of a field. The patent discloses the use of dyes in either the polymer encapsulant or liquid crystal to absorb incident light. The patent further discloses the use of a chiral dopant. The dopant improves the response time of the nematic liquid crystal, but does not cause the nematic host to operate in a bistable light-reflective state.

U.S. Pat. No. 5,251,048 to Doane et al. discloses a light-modulating cell having a polymer-dispersed chiral-nematic liquid crystal. The chiral-nematic liquid crystal has the property of being electrically driven between a planar state, reflecting a specific visible wavelength of light, and a focal-conic state, transmitting forward scattering light. Chiral-nematic liquid crystals, also known as cholesteric liquid crystals, potentially in some circumstances have the capacity of maintaining one of multiple given states in the absence of an electric field. Black paint can be applied to the outer surface of a rear substrate to provide a light-absorbing layer forming a non-changing background outside of a changeable display area defined by the intersection of segment lines and scanning lines.

U.S. Pat. No. 5,636,044 to Yuan et al. discloses a seven-segment display, using cholesteric liquid-crystal material, which display has two substrates. The substrates are rigid glass with patterned transparent electrodes on each of two facing surfaces. A continuum of cholesteric liquid crystal fills the gap between the two electrode sets. The first substrate is divided into segmented and non-segmented areas which are defined by gaps in transparent, electrically conductive Indium-Tin-Oxide (ITO) disposed on the substrate. The second substrate is divided into common electrodes in an ITO coating corresponding to segmented and non-segmented areas on the first substrate. The device can change the state of the segmented areas as well as non-segmented areas, permitting the display of a positive or negative image. Both electrodes are transparent electrodes, requiring an additional light-absorbing layer on the back of one substrate. Inter-segment material, or gaps in the electrode materials, requires electrode contacts to each segment area to write; requiring separate electrical connection to each segment area. It would be useful to have a structure that could provide simple electrodes connect to each segment area, in a matrix fashion, without requiring point connection to each segment area.

U.S. Pat. No. 6,236,442 to Stephenson et al. discloses a display sheet with a metallic conductive layer over a cholesteric layer. A process is disclosed for vacuum depositing a continuous metallic layer and laser patterning the metallic layer to form segment electrodes. Areas between etched segments remain in an as-coated state. A circuit board with contacts is pressed against each segment electrode. The circuit board provides electrical drive to segment electrodes.

U.S. Pat. No. 6,3323,928 to Petruchik et al discloses a colored dielectric layer, in one case a black dye, that matches the color of the conductor. The conductor must be dark to provide contrast when a cholesteric layer is electrically written into the focal-conic state. In particular, Petruchik et al. uses a dyed dielectric layer to match the dark state of the printed segment areas in the focal conic state. In one embodiment, a dielectric area with openings to each opaque conductive area is printed over the opaque conductive material. Traces are then printed over the dielectric layer to eliminate a circuit board with contacts.

There is a need for a segmented display using cholesteric liquid-crystals or the like and having inter-segment regions, the optical properties of which more closely match the optical properties of the written segments in the display.

### PROBLEM TO BE SOLVED

Matrix displays having an imaging layer comprising a light-modulating material, a light-absorbing layer that allows a portion of the light in the visible spectrum to be transmitted, and reflective conductors, for example a polymer dispersed cholesteric layer, have a sub-optimal appearance unless the materials between segments match the reflectivity of the reflective conductors. Although this can be achieved by providing electrically isolated inter-segment areas of the same material (for example, a printed ink made of silver) as the reflective conductors, two problems can occur. First, since both the inter-segment materials and the segmented reflective conductors are conductive, they must be electrically isolated from each other and the gap or areas between the segmented reflective conductors and the inter-segment materials do not have a reflectivity that matches either the inter-segment materials or the segmented conductors. Thus, an undesirable “halo” can be formed around changeable display areas. Furthermore, the use of silver or other preferred conductive materials in both the segmented reflective conductors and the inter-segment materials is expensive.

### SUMMARY OF THE INVENTION

These problems are solved by employing a dielectric material in the inter-segment area that has an optical reflection that matches the reflectivity of the reflective conductors under the light-modulating layer of the display.

In one embodiment of the invention, a display sheet comprises in order:
a) a substrate;
b) transparent first conductors;
c) a light-modulating material disposed over the first transparent conductors and having different first and second field-changeable stable optical states, a transmissive and a reflective state;
d) a light-absorbing layer, over the light-modulating layer, that absorbs a portion of the visible spectrum and transmits a portion of the visible spectrum;
e) substantially reflective second conductors forming conductive segments, over a plurality of segmented areas of the light-absorbing layer, that operate in conjunction with the light-absorbing layer to provide reflective light additional to that provided by the light-modulating material; and
f) substantially reflective non-conductive material, disposed over one or more background areas of light-absorbing layers not covered by second conductors, to provide reflective light additional to that provided by the light-modulating material such that the total reflected light in background areas more closely match the total reflected light in the segmented areas when both areas are in the same optical state.

In one preferred embodiment, the display comprises a display area capable of displaying a plurality of characters, each character having a character region and a background region, wherein each character region comprises a plurality of segments, wherein said character region corresponds to at least one of the transparent first conductors, the second conductors are patterned to have electrically separate areas corresponding to the segments of the character region; and the substantially reflective non-conductive material is an inter-segment background element, corresponding to the background region, comprising one or more sections, the upper surfaces of the background element and the second conductors being substantially in the same plane, in a plane parallel to the mid-plane of the display element. The background element can be in touch, or overlap the peripheral boundary of the patterned areas of the second conductors. Optionally, third conductors can be connected to second conductors in more than one character region.

In one particular embodiment of the invention, at least one imaging layer comprising a light-modulating material disposed between the first and second conductors, which material has the property of having a first and second field-switchable stable optical state which states correspond, respectively, to a first and second contrasting optically visible state, and which material has the further property, when coated on a substrate and before application of an electromagnetic field, of exhibiting an as-coated optical appearance that is nearer to the first optically visible state (for example, a reflective state in a liquid-crystal display) and, after being subjected to a field (such as capable of switching from the second visible state to the first visible state) of exhibiting a field-induced optical appearance (for example, the reflective state corresponding to a planar orientation in a liquid-crystal material).

Preferably, the reflectivity of the second conductors and the reflectivity of the substantially reflective non-conductive material are substantially equivalent. However, the reflectivity of the non-conductive material is preferably, to some minor extent, greater than that of the second conductors. This allows, in the preferred embodiment, the reflectivity of the non-conductive material to be used to substantially compensate for the lower reflectivity of the as-coated light-modulating material in background areas, as compared to the higher reflectivity of the electrically induced reflective state in changeable display areas. Thus, the substantially reflective second conductor and the substantially reflective non-conductive material can be used to control and provide, in conjunction with the overlying layers, substantially equivalent optical appearances for the corresponding display areas when in the same optical state.

### ADVANTAGEOUS EFFECT OF THE INVENTION

The invention has the advantage of improving the display appearance of cholesteric displays and can eliminate objectionable halos around segments in segmented displays and/or can eliminate or reduce differences in the appearance of as-coated background areas and the changeable display areas, especially when in the reflective optical state.

### BRIEF DESCRIPTION OF THE DRAWINGS

FIG. 1 is a perspective section view of one embodiment of a display in accordance with the present invention;

FIGS. 2A and 2B are schematic sectional views of a chiral nematic material, respectively, in a planar and focal-conic state responding to incident light;

FIG. 3 is a plot of the spectra for a polymer-dispersed liquid-crystal material in the planar and focal-conic states;

FIG. 4 is a side section view of a display made in accordance with first prior art;

FIG. 5 is a side section view of a display made in accordance with second prior art;

FIG. 6 is a side section view made in accordance with the present invention;

FIG. 7 is a rear view of a sheet in accordance with the present invention having patterned first conductors;

FIG. 8 is a rear view of a sheet in accordance with the present invention having a polymer-dispersed cholesteric liquid-crystal layer and a dark layer;

FIG. 9 is a rear view of a sheet in accordance with the present invention having exposed first conductors;

FIG. 10 is a rear view of a display in accordance with the present invention having second conductors;

FIG. 11 is a sectional rear view of a display in accordance with the present invention having a printed reflectance matching dielectric layer;

FIG. 12 is a rear view of a display in accordance with the present invention having printed row contacts;

FIG. 13 is a section view of a display in accordance with the present invention attached to a circuit board; and

FIG. 14 is a front view of a display in accordance with the present invention connected to electric drive means.

### DETAILED DESCRIPTION OF THE INVENTION

The present invention relates to a display and method of making the display comprising a substrate or support, a patterned conductor, and a liquid crystal material having cleared areas and electrically writable areas.

The support bears an electrically modulated imaging layer over at least one surface. As used herein, the terms “over,” “above,” “on,” “under,” and the like, with respect to layers in the display element, refer to the order of the layers over the support, but do not necessarily indicate that the layers are immediately adjacent or that there are no intermediate layers. The term “front,” “upper,” and the like refer to the side of the display element closer to the side being viewed during use.

The “light-modulating material” according to the present invention may be an electrically modulated material and may include a thermo-chromic material. A thermo-chromic material is capable of changing its state alternately between transparent and opaque upon the application of heat. In this manner, a thermo-chromic imaging material develops images through the application of heat at specific pixel locations in order to form an image. The thermo-chromic imaging material retains a particular image until heat is again applied to the material.

The light-modulated material may also include surface stabilized ferroelectric liquid crystals (SSFLC). Surface stabilized ferroelectric liquid crystals confining ferroelectric liquid crystal material between closely-spaced glass plates to suppress the natural helix configuration of the crystals. The cells switch rapidly between two optically distinct, stable states simply by alternating the sign of an applied electric field.

Those skilled in the art will recognize that a variety of bi-stable non-volatile imaging materials are available and may be implemented in the present invention. The light-modulating material employed in connection with the present invention preferably has the characteristic that it does not require power to maintain display of indicia.

The light-modulating material may also be configured as a single color, such as black, white or clear, and may be fluorescent, iridescent, bioluminescent, incandescent, ultraviolet, infrared, or may include a wavelength specific radiation absorbing or emitting material. There may be multiple layers of light-modulating material. Different layers or regions of the electrically modulated material may have different properties or colors. Moreover, the characteristics of the various layers may be different from each other. For example, one layer can be used to view or display information in the visible light range, while a second layer responds to or emits ultraviolet light.

The preferred light-modulating material for an imaging layer comprises a liquid crystalline material. Liquid crystals can be nematic (N), chiral nematic (N*), or smectic, depending upon the arrangement of the molecules in the mesophase. Chiral nematic liquid crystal (N*LC) displays are typically reflective, that is, no backlight is needed, and can function without the use of polarizing films or a color filter.

Chiral-nematic liquid crystal refers to the type of liquid crystal having finer pitch than that of twisted nematic and super-twisted nematic used in commonly encountered LC devices. Chiral-nematic liquid crystals are so named because such liquid crystal formulations are commonly obtained by adding chiral agents to host nematic liquid crystals. Chiral-nematic liquid crystals may be used to produce bi-stable or multi-stable displays. These devices have significantly reduced power consumption due to their non-volatile “memory” characteristic. Since such displays do not require a continuous driving circuit to maintain an image, they consume significantly reduced power. Chiral-nematic displays are bistable in the absence of a field; the two stable textures are the reflective planar texture and the weakly scattering focal conic texture.

In the planar texture, the helical axes of the chiral-nematic liquid crystal molecules are substantially perpendicular to the substrate upon which the liquid crystal is disposed. In the focal-conic state the helical axes of the liquid crystal molecules are generally randomly oriented. Adjusting the concentration of chiral dopants in the chiral-nematic material modulates the pitch length of the mesophase and, thus, the wavelength of radiation reflected. Chiral-nematic materials that reflect infrared radiation and ultraviolet have been used for purposes of scientific study. Commercial displays are most often fabricated from chiral-nematic materials that reflect visible light. Some known LCD devices include chemically etched, transparent, conductive layers overlying a glass substrate as described in U.S. Pat. No. 5,667,853, incorporated herein by reference.

In one embodiment, a chiral-nematic liquid crystal composition may be dispersed in a continuous matrix. Such materials are referred to as “polymer-dispersed liquid crystal” materials or “PDLC” materials. Such materials can be made by a variety of methods. For example, Doane et al. (Applied Physics Letters, 48, 269 (1986)) disclose a PDLC comprising approximately 0.4 mm droplets of nematic liquid crystal 5CB in a polymer binder. A phase separation method is used for preparing the PDLC. A solution containing monomer and liquid crystal is filled in a display cell and the material is then polymerized. Upon polymerization the liquid crystal becomes immiscible and nucleates to form droplets. West et al. (Applied Physics Letters 63, 1471 (1993)) disclose a PDLC comprising a chiral nematic mixture in a polymer binder. Once again a phase separation method is used for preparing the PDLC. The liquid crystal material and polymer (a hydroxy functionalized polymethylmethacrylate) along with a cross-linker for the polymer are dissolved in a common organic solvent toluene and coated on an indium tin oxide (ITO) substrate. A dispersion of the liquid-crystal material in the polymer binder is formed upon evaporation of toluene at high temperature.

In one embodiment of the invention, a liquid crystal material may be applied as a substantial monolayer. The term “substantial monolayer” is defined by the Applicants to mean that, in a direction perpendicular to the plane of the display, there is no more than a single layer of domains sandwiched between the electrodes at most points of the display (or the imaging layer), preferably at 75 percent or more of the points (or area) of the display, most preferably at 90 percent or more of the points (or area) of the display. In other words, at most, only a minor portion (preferably less than 10 percent) of the points (or area) of the display has more than a single domain (two or more domains) between the electrodes in a direction perpendicular to the plane of the display, compared to the amount of points (or area) of the display at which there is only a single domain between the electrodes.

The amount of material needed for a monolayer can be accurately determined by calculation based on individual domain size, assuming a fully closed packed arrangement of domains. (In practice, there may be imperfections in which gaps occur and some unevenness due to overlapping droplets or domains.) On this basis, the calculated amount is preferably less than about 150 percent of the amount needed for monolayer domain coverage, preferably not more than about 125 percent of the amount needed for a monolayer domain coverage, more preferably not more than 110 percent of the amount needed for a monolayer of domains. Furthermore, improved viewing angle and broadband features may be obtained by appropriate choice of differently doped domains based on the geometry of the coated droplet and the Bragg reflection condition.

In a preferred embodiment of the invention, the display device or display sheet has simply a single imaging layer of liquid crystal material along a line perpendicular to the face of the display, preferably a single layer coated on a flexible substrate. Such a structure, as compared to vertically stacked imaging layers each between opposing substrates, is especially advantageous for monochrome shelf labels and the like. Structures having stacked imaging layers, however, are optional for providing additional advantages in some case.

Preferably, the domains are flattened spheres and have on average a thickness substantially less than their length, preferably at least 50% less. More preferably, the domains on average have a thickness (depth) to length ratio of 1:2 to 1:6. The flattening of the domains can be achieved by proper formulation and sufficiently rapid drying of the coating. The domains preferably have an average diameter of 2 to 30 microns. The imaging layer preferably has a thickness of 10 to 150 microns when first coated and 2 to 20 microns when dried.

The flattened domains of liquid crystal material can be defined as having a major axis and a minor axis. In a preferred embodiment of a display or display sheet, the major axis is larger in size than the cell (or imaging layer) thickness for a majority of the domains. Such a dimensional relationship is shown in U.S. Pat. No. 6,061,107, hereby incorporated by reference in its entirety.

Modern chiral-nematic liquid crystal materials usually include at least one nematic host combined with a chiral dopant. In general, the nematic liquid crystal phase is composed of one or more mesogenic components combined to provide useful composite properties. Many such materials are available commercially. The nematic component of the chiral-nematic liquid crystal mixture may be comprised of any suitable nematic liquid crystal mixture or composition having appropriate liquid crystal characteristics. The nematic liquid crystal phases typically consist of 2 to 20, preferably 2 to 15 components. The above list of materials is not intended to be exhaustive or limiting. The lists disclose a variety of representative materials suitable for use or mixtures, which comprise the active element in electro-optic liquid crystal compositions.

Suitable chiral-nematic liquid crystal compositions preferably have a positive dielectric anisotropy and include chiral material in an amount effective to form focal conic and twisted planar textures. Chiral-nematic liquid crystal materials are preferred because of their excellent reflective characteristics, bi-stability and gray scale memory. The chiral-nematic liquid crystal is typically a mixture of nematic liquid crystal and chiral material in an amount sufficient to produce the desired pitch length. Suitable commercial nematic liquid crystals include, for example, E7, E44, E48, E31, E80, BL087, BL101, ZLI-3308, ZLI-3273, ZLI-5048-000, ZLI-5049-100, ZLI-5100-100, ZLI-5800-000, MLC-6041-100.TL202, TL203, TL204 and TL205 manufactured by E. Merck (Darmstadt, Germany). Although nematic liquid crystals having positive dielectric anisotropy, and especially cyanobiphenyls, are preferred, virtually any nematic liquid crystal known in the art, including those having negative dielectric anisotropy should be suitable for use in the invention. Other nematic materials may also be suitable for use in the present invention as would be appreciated by those skilled in the art.

The chiral dopant added to the nematic mixture to induce the helical twisting of the mesophase, thereby allowing reflection of visible light, can be of any useful structural class. The choice of dopant depends upon several characteristics including among others its chemical compatibility with the nematic host, helical twisting power, temperature sensitivity, and light fastness. Many chiral dopant classes are known in the art: e.g., G. Gottarelli and G. Spada, Mol. Cryst. Liq. Crys., 123, 377 (1985); G. Spada and G. Proni, Enantiomer, 3, 301 (1998), U.S. Pat. No. 6,217,792; U.S. Pat. No. 6,099,751; and U.S. patent application Ser. No. 10/651,692, hereby incorporated by reference.

Chiral-nematic liquid crystal materials and cells, as well as polymer stabilized chiral nematic liquid crystals and cells, are well known in the art and described in, for example, U.S. Pat. No. 5,437,811; Yang et al., Appl. Phys. Lett. 60(25) pp 3102-04 (1992); Yang et al., J. Appl. Phys. 76(2) pp 1331 (1994); published International Patent Application No. PCT/US92/09367; and published International Patent Application No. PCT/US92/03504, all of which are incorporated herein by reference.

The liquid crystalline droplets or domains may be formed by any method, known to those of skill in the art, which will allow control of the domain size. Liquid crystal domains are preferably made using a limited coalescence methodology, as disclosed in U.S. Pat. Nos. 6,556,262 and 6,423,368, incorporated herein by reference. Limited coalescence is defined as dispersing a light-modulating material below a given size, and using coalescent limiting material to limit the size of the resulting domains. Such materials are characterized as having a ratio of maximum to minimum domain size of less than 2:1. By use of the term “uniform domains,” it is meant that domains are formed having a domain size variation of less than 2:1. Limited domain materials have improved optical properties.

Suitable polymeric binders for polymer-dispersed liquid crystal materials include both naturally occurring substances such as proteins, protein derivatives, cellulose derivatives (e.g. cellulose esters), gelatins and gelatin derivatives, polysaccaharides, casein, and the like, and synthetic water permeable colloids such as poly(vinyl lactams), acrylamide polymers, poly(vinyl alcohol) and its derivatives, hydrolyzed polyvinyl acetates, polymers of alkyl and sulfoalkyl acrylates and methacrylates, polyamides, polyvinyl pyridine, acrylic acid polymers, maleic anhydride copolymers, polyalkylene oxide, methacrylamide copolymers, polyvinyl oxazolidinones, maleic acid copolymers, vinyl amine copolymers, methacrylic acid copolymers, acryloyloxyalkyl acrylate and methacrylates, vinyl imidazole copolymers, vinyl sulfide copolymers, and homopolymer or copolymers containing styrene sulfonic acid. Gelatin is preferred.

Gelatin, containing hardener, may optionally be used in the present invention. In the context of this invention, hardeners are defined as any additive, which causes chemical crosslinking in gelatin or gelatin derivatives. Many conventional hardeners are known to crosslink gelatin. Gelatin crosslinking agents (i.e., the hardener) are included in an amount of at least about 0.01 wt. % and preferably from about 0.1 to about 10 wt. % based on the weight of the solid dried gelatin material used (by dried gelatin is meant substantially dry gelatin at ambient conditions as for example obtained from Eastman Gel Co., as compared to swollen gelatin), and more preferably in the amount of from about 1 to about 5 percent by weight. More than one gelatin crosslinking agent can be used if desired. Suitable hardeners, both organic and inorganic are described in commonly assigned, copending U.S. Ser. No. 10/619,329, Filed Jul. 14, 2003, hereby incorporated by reference. Other examples of hardening agents can be found in standard references such as The Theory of the Photographic Process, T. H. James, Macmillan Publishing Co., Inc. (New York 1977) or in Research Disclosure, September 1996, Vol. 389, Part IIB (Hardeners) or in Research Disclosure, September 1994, Vol. 365, Item 36544, Part IIB (Hardeners). Research Disclosure is published by Kenneth Mason Publications, Ltd., Dudley House, 12 North St., Emsworth, Hampshire P010 7DQ, England.

A preferred class of hardeners are compounds comprising two or more vinyl sulfonyl groups. These compounds are hereinafter referred to as “vinyl sulfones.” Compounds of this type are described in numerous patents including, for example, U.S. Pat. Nos. 3,490,911; 3,642,486; 3,841,872; and 4,171,976. Vinyl sulfone hardeners are believed to be effective as hardeners as a result of their ability to crosslink polymers making up the colloid.

As used herein, the phase a “liquid crystal display” (LCD) is a type of flat panel display used in various electronic devices. At a minimum, an LCD comprises a substrate, at least one conductive layer and a liquid crystal layer. LCDs may also optionally comprise two sheets of polarizing material with a liquid crystal solution between the polarizing sheets. The sheets of polarizing material may comprise a substrate of glass or transparent plastic. The LCD may also include functional layers. In one embodiment of an LCD, a transparent, multilayer flexible support is coated with a first conductive layer, which may be patterned, onto which is coated the light-modulating liquid crystal layer. A second conductive layer is applied and overcoated with a dielectric layer to which dielectric conductive row contacts are attached, including via that permit interconnection between conductive layers and the dielectric conductive row contacts. An optional nanopigmented functional layer may be applied between the liquid crystal layer and the second conductive layer.

A liquid crystal (LC) element can also include an optical switch. The substrates for such devices are usually manufactured with transparent, conductive electrodes, in which electrical “driving” signals are coupled. The driving signals induce an electric field which can cause a phase change or state change in the LC material, the LC exhibiting different light-reflecting characteristics according to its phase and/or state.

An LCD contains at least one conductive layer, which typically is comprised of a primary metal oxide. This conductive layer may comprise other metal oxides such as indium oxide, titanium dioxide, cadmium oxide, gallium indium oxide, niobium pentoxide and tin dioxide. See, Int. Publ. No. WO 99/36261 by Polaroid Corporation. In addition to the primary oxide such as ITO, the at least one conductive layer can also comprise a secondary metal oxide such as an oxide of cerium, titanium, zirconium, hafnium and/or tantalum. See, U.S. Pat. No. 5,667,853 to Fukuyoshi et al. (Toppan Printing Co.) Other transparent conductive oxides include, but are not limited to ZnO₂, Zn₂SnO₄, Cd₂SnO₄, Zn₂In₂O₅, MgIn₂O₄, Ga₂O₃—In₂O₃, or TaO₃. The conductive layer may be formed, for example, by a low temperature sputtering technique or by a direct current sputtering technique, such as DC-sputtering or RF-DC sputtering, depending upon the material or materials of the underlying layer. The conductive layer may be a transparent, electrically conductive layer of tin-oxide or indium-tin-oxide (ITO), or polythiophene, with ITO being the preferred material. Typically, the conductive layer is sputtered onto the substrate to a resistance of less than 250 ohms per square. Alternatively, the conductive layer may be an opaque electrical conductor formed of metal such as copper, aluminum or nickel. If the conductive layer is an opaque metal, the metal can be a metal oxide to create a light absorbing conductive layer.

Indium tin oxide (ITO) is a preferred conductive material, as it is a cost effective conductor with good environmental stability, up to 90% transmission, and down to 20 ohms per square resistivity. An exemplary preferred ITO layer has a % T greater than or equal to 80% in the visible region of light, that is, from greater than 400 nm to 700 nm, so that the film will be useful for display applications. In a preferred embodiment, the conductive layer comprises a layer of low temperature ITO which is polycrystalline. The ITO layer is preferably 10-120 nm in thickness, or 50-100 nm thick to achieve a resistivity of 20-60 ohms/square on plastic. An exemplary preferred ITO layer is 60-80 nm thick.

The conductive layer is preferably patterned. The conductive layer is preferably patterned into a plurality of electrodes. The patterned electrodes may be used to form a LCD device. In another embodiment, two conductive substrates are positioned facing each other and cholesteric liquid crystals are positioned therebetween to form a device. The patterned ITO conductive layer may have a variety of dimensions. Exemplary dimensions may include line widths of 10 microns, distances between lines, that is, electrode widths, of 200 microns, depth of cut, that is, thickness of ITO conductor, of 100 nanometers. ITO thicknesses on the order of 60, 70, and greater than 100 nanometers are also possible.

The display may also contain a second conductive layer applied to the surface of the light-modulating layer. The second conductive layer desirably has sufficient conductivity to carry a field across the light-modulating layer. The second conductive layer may be formed in a vacuum environment using materials such as aluminum, tin, silver, platinum, carbon, tungsten, molybdenum, or indium. Oxides of these metals can be used to darken patternable conductive layers. The metal material can be excited by energy from resistance heating, cathodic arc, electron beam, sputtering or magnetron excitation. The second conductive layer may comprise coatings of tin-oxide or indium-tin oxide, resulting in the layer being transparent. Alternatively, second conductive layer may be printed conductive ink.

For higher conductivities, the second conductive layer may comprise a silver-based layer which contains silver only or silver containing a different element such as aluminum (Al), copper (Cu), nickel (Ni), cadmium (Cd), gold (Au), zinc (Zn), magnesium (Mg), tin (Sn), indium (In), tantalum (Ta), titanium (Ti), zirconium (Zr), cerium (Ce), silicon (Si), lead (Pb) or palladium (Pd). In a preferred embodiment, the conductive layer comprises at least one of gold, silver and a gold/silver alloy, for example, a layer of silver coated on one or both sides with a thinner layer of gold. See, Int. Publ. No. WO 99/36261 by Polaroid Corporation. In another embodiment, the conductive layer may comprise a layer of silver alloy, for example, a layer of silver coated on one or both sides with a layer of indium cerium oxide (InCeO). See U.S. Pat. No. 5,667,853, incorporated herein in by reference.

The second conductive layer may be patterned irradiating the multi-layered conductor/substrate structure with ultraviolet radiation so that portions of the conductive layer are ablated therefrom. It is also known to employ an infra-red (IR) fiber laser for patterning a metallic conductive layer overlying a plastic film, directly ablating the conductive layer by scanning a pattern over the conductor/film structure. See: Int. Publ. No. WO 99/36261 and “42.2: A New Conductor Structure for Plastic LCD Applications Utilizing ‘All Dry’ Digital Laser Patterning,” 1998 SID International Symposium Digest of Technical Papers, Anaheim, Calif., May 17-22, 1998, no. VOL. 29, May 17, 1998, pages 1099-1101, both incorporated herein by reference.

The LCD may also comprise at least one “functional layer” between the conductive layer and the substrate. The functional layer may comprise a protective layer or a barrier layer. The protective layer useful in the practice of the invention can be applied in any of a number of well known techniques, such as dip coating, rod coating, blade coating, air knife coating, gravure coating and reverse roll coating, extrusion coating, slide coating, curtain coating, and the like. The lubricant particles and the binder are preferably mixed together in a liquid medium to form a coating composition. The liquid medium may be a medium such as water or other aqueous solutions in which the hydrophilic colloid are dispersed with or without the presence of surfactants. A preferred barrier layer may act as a gas barrier or a moisture barrier and may comprise SiOx, AlOx or ITO. The protective layer, for example an acrylic hard coat, functions to prevent laser light from penetrating to functional layers between the protective layer and the substrate, thereby protecting both the barrier layer and the substrate. The functional layer may also serve as an adhesion promoter of the conductive layer to the substrate.

In another embodiment, the polymeric support may further comprise an antistatic layer to manage unwanted charge build up on the sheet or web during roll conveyance or sheet finishing. In another embodiment of this invention, the antistatic layer has a surface resistivity of between 105 to 1012. Above 1012, the antistatic layer typically does not provide sufficient conduction of charge to prevent charge accumulation to the point of preventing fog in photographic systems or from unwanted point switching in liquid crystal displays. While layers greater than 105 will prevent charge buildup, most antistatic materials are inherently not that conductive and in those materials that are more conductive than 105, there is usually some color associated with them that will reduce the overall transmission properties of the display. The antistatic layer is separate from the highly conductive layer of ITO and provides the best static control when it is on the opposite side of the web substrate from that of the ITO layer. This may include the web substrate itself.

Another type of functional layer may be a color contrast layer. Color contrast layers may be radiation reflective layers or radiation absorbing layers. In some cases, the rearmost substrate of each display may preferably be painted black. The color contrast layer may also be other colors. In another embodiment, the dark layer comprises milled nonconductive pigments. The materials are milled below 1 micron to form “nano-pigments.” In a preferred embodiment, the dark layer absorbs all wavelengths of light across the visible light spectrum, that is from 400 nanometers to 700 nanometers wavelength. The dark layer may also contain a set or multiple pigment dispersions. Suitable pigments used in the color contrast layer may be any colored materials, which are practically insoluble in the medium in which they are incorporated. Suitable pigments include those described in Industrial Organic Pigments: Production, Properties, Applications by W. Herbst and K. Hunger, 1993, Wiley Publishers. These include, but are not limited to, Azo Pigments such as monoazo yellow and orange, diazo, naphthol, naphthol reds, azo lakes, benzimidazolone, diazo condensation, metal complex, isoindolinone and isoindolinic, polycyclic pigments such as phthalocyanine, quinacridone, perylene, perinone, diketopyrrolo-pyrrole, and thioindigo, and anthriquinone pigments such as anthrapyrimidine.

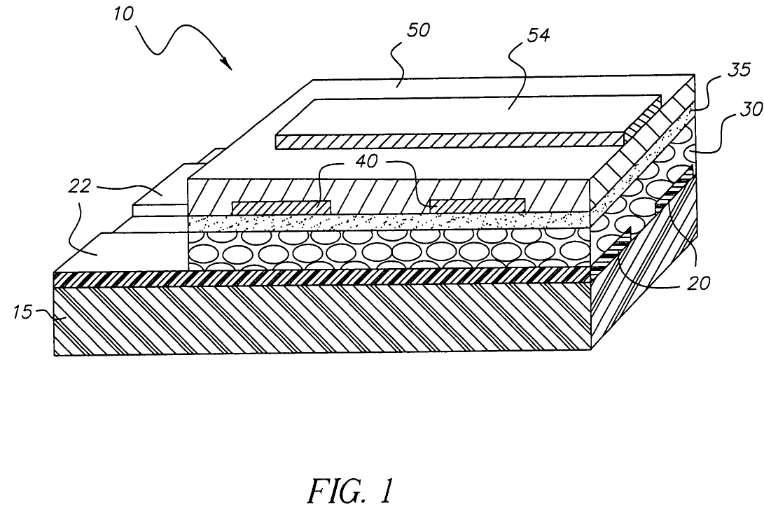

FIG. 1 is a perspective section view of one preferred embodiment of a display in accordance with the invention, which display employs a polymer-dispersed cholesteric material. A sheet designated as display 10 is made in accordance with the present invention. Display 10 includes a display substrate 15, which can be a thin transparent polymeric material, such as Kodak Estar® film base formed of polyester plastic that has a thickness of between 20 and 200 micrometers. In an exemplary embodiment, display substrate 15 is a 125-micrometer thick sheet of polyester film base. Other polymers, such as transparent polycarbonate, can also be used.

One or more first transparent conductors 20 are formed on display substrate 15. First transparent conductors 20 can be tin-oxide, indium-tin-oxide (ITO), or polythiophene, with ITO being the preferred material. Typically the material of first transparent conductors 20 is sputtered or coated as a layer over display substrate 15 having a resistance of less than 1000 ohms per square. First transparent conductors 20 can be formed in the conductive layer by conventional lithographic or laser etching means. Transparent first transparent conductors 20 can also be formed by printing a transparent organic conductor such as PEDT/PSS, PEDOT/PSS polymer, which materials are sold as Baytron® P by Bayer AG Electronic Chemicals. Portions of first transparent conductors 20 can be uncoated to provide exposed first conductors 22 for this embodiment.

Cholesteric layer 30 overlays first transparent conductors 20. Cholesteric layer 30 contains cholesteric liquid-crystal material, such as those disclosed in U.S. Pat. No. 5,695,682 to Doane et al., the disclosure of which is incorporated by reference. Such materials are made using highly anisotropic nematic liquid crystal mixtures and adding a chiral doping agent to provide helical twist in the planes of the liquid crystal to the point that interference patterns are created that reflect incident light. Application of electrical fields of various intensity and duration can be employed to drive a chiral-nematic (cholesteric) material into a reflective state, to near-transparent or transmissive state, or an intermediate state. These materials have the advantage of having first and second optical states that are both stable in the absence of an electrical field. The materials can maintain a given optical state indefinitely after the field is removed. Cholesteric liquid crystal materials can be formed, for example, using a two-component system such as MDA-00-1444 (undoped nematic) and MDA-00-4042 (nematic with high chiral dopant concentrations) available from E.M. Industries of Hawthorne, N.Y.

In a preferred embodiment, cholesteric layer 30 is a cholesteric material dispersed in deionized photographic gelatin. The liquid crystal material is mixed at 8% cholesteric liquid crystal in a 5% gelatin aqueous solution. The mixture is dispersed to create an emulsion having 8-10 micrometer diameter domains of the liquid crystal in aqueous suspension. The domains can be formed using the limited coalescence technique described in U.S. Pat. No. 6,690,436 by Stephenson et al. The emulsion is coated over first transparent conductors 20 on a polyester display substrate 15 and dried to provide an approximately 9-micrometer thick polymer dispersed cholesteric coating. Other organic binders such as polyvinyl alcohol (PVA) or polyethylene oxide (PEO) can be used in place of the gelatin. Such emulsions are machine coatable using coating equipment of the type employed in the manufacture of photographic films. A gel sub-layer can be applied over first transparent conductors 20 prior to applying cholesteric layer 30 as disclosed in U.S. Pat. No. 6,423,368 by Stephenson et al., hereby incorporated by reference in its entirety.

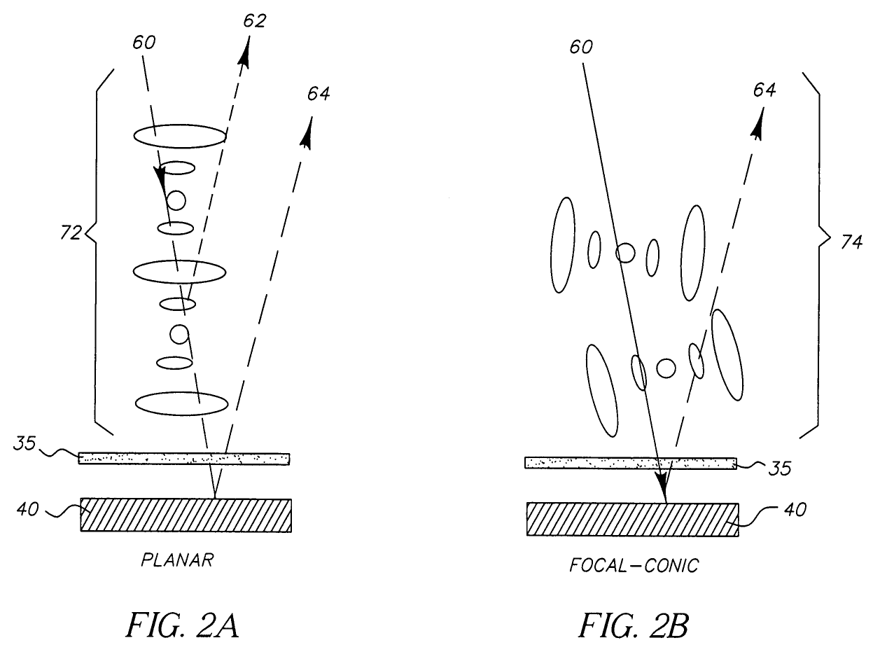

FIGS. 2A and 2B are schematic section views of optical states of one embodiment of a display in accordance with the present invention. FIG. 2A demonstrates the optical path when the cholesteric material is in a planar state. Incident light 60 strikes planar liquid crystal 72 which reflects a portion of incident light 60 as reflected light 62. Dark layer 35 is a light-absorbing dye layer that operates on a portion of the light passing though dark layer 35. Particular wavelengths of light are absorbed, and the remaining light strikes reflective second conductor 40. Light is reflected from second conductor 40 and passes through dark layer 35 a second time, then passes through planar liquid crystal 72 to become complementary light 64. In a preferred embodiment, complementary light 64, operating in conjunction with cholesteric liquid crystal having peak reflectance near 575 nanometers, is complementary to light 62, thereby forming a substantially color-neutral appearance. In accordance with copending U.S. patent application Ser. No. 10/832,520, hereby incorporated by reference in its entirety, different color combinations of the reflective and transmissive states can be pre-designed.

Shown in FIG. 2B, the liquid-crystal material is in a focal-conic state 74 and transmits incident light 60. Dark layer 35 provides complementary light 64 when the liquid crystal material is in a focal conic state.

In one embodiment of the invention, the polymer-dispersed cholesteric material as-coated assumes a near-planar state (“nP”) which is less reflecting compared to the planar state obtained by an electrical field, in an area of an image or other information formed during display use. The amount of reflected light 62 is less. The cholesteric material is bright but does not match the reflectance of the cholesteric material when it is electronically written into the planar state.

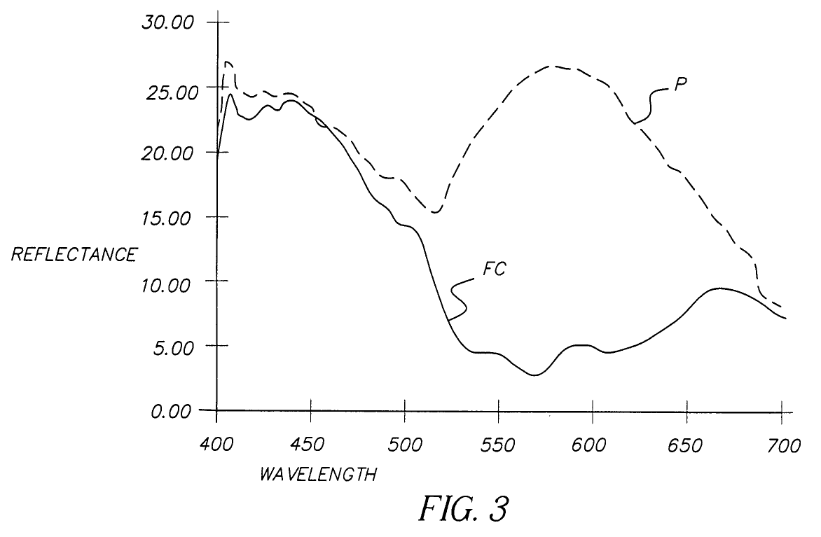

For example, FIG. 3 is a plot of the spectra for a yellow polymer-dispersed cholesteric liquid-crystal material with a blue dark layer in the planar (P), focal-conic (FC) states. When the cholesteric material is in the planar state, the display appears substantially color neutral having a light gray or white color. When the display is written into the focal-conic state, the display appears blue.

In the as-coated, electrically unwritten near planar (nP) state, the display does not have the full reflectance of the planar (P) state and has an appearance different from an electrically written planar state. Displays that do not electrically activate the full surface area, such as seven-segment displays, will have characters in optical states that do not match the background state. Similarly, in the case where the dark layer is black, the as-coated state in the near-planar (nP) will also differ from the reflectance of polymer-dispersed cholesteric liquid-crystal material electrically written into the planar state. It should also be recognized that although the spectra for a polymer-dispersed cholesteric liquid-crystal material in the near-planar (nP) state is usually below the spectra of the material in the planar (P) state, the point of significance is that the two spectra do not match well and, for example, the spectra of the material in the near-planar (nP) state could be above the spectra of the material in the planar (P) in other embodiments.

Thus, the skilled artisan will appreciate that any regions in a display having as-coated chiral nematic material may not match ideally well the regions in a display having chiral nematic material exhibiting optical states obtained during display use, a problem described in U.S. Pat. No. 5,636,044 to Yuan et al., hereby incorporated by reference in its entirety. The skilled artisan will also recognize that a chiral-nematic material can provide a gray scale in which case the optical states referred to in this application preferably correspond to lightest and darkest contrasting states. One optional advantage of the present invention, is that in addition to providing, by means of a substantially reflective non-conductive or dielectric material, a more similar or closely matched optical appearance between the areas of the imaging layer over the second conductors and the areas of the imaging layer not over the second conductors, the substantially reflective non-conductive or dielectric material can also be used optionally to compensate for the difference between near planar and planar states, for example, by adjusting the formulation of the material.

Returning to FIG. 1, dark layer 35 overlays cholesteric layer 30. In a preferred embodiment, dark layer 35 is a complementary light-absorbing layer composed of pigments that are milled below 1 micrometer to form “nano-pigments” in a binder. Such pigments are very effective in absorbing wavelengths of light in very thin (sub-micrometer) layers. Such pigments can be selected to be electrically inert to prevent degradation interference from electrical display fields applied to display 10. Such pigments are disclosed in copending U.S. patent application Ser. No. 10/455,050, filed Jun. 5, 2003, hereby incorporated by reference.

In the present embodiment, in FIG. 1, dark layer 35 is coated over cholesteric layer 30 to provide a light-absorbing layer that provides a specific contrast state to reflected light. As mentioned above, dark layer 35 can be designed to provide a specific amount of light at wavelengths not operated on by the cholesteric liquid crystal to create a more color-neutral image. The coating can be simultaneous with the deposition of cholesteric layer 30 or as a separate step. In a preferred embodiment, multi-layer coating equipment of the kind used in the photographic industry provides cholesteric layer 30 and dark layer 35 as two co-deposited layers. Dark layer 35 is significantly thinner than cholesteric layer 30 and has minimal effect on the electrical field strength required to change the state of the cholesteric liquid-crystal material.

Second conductors 40 overlay dark layer 35. Second conductors 40 have sufficient conductivity to induce an electric field across cholesteric layer 30 strong enough to change the optical state of the polymeric material. Second conductors 40, in this application which requires complementary light 64, are formed of reflective metal, for example, by vacuum deposition of conductive and reflective material such as aluminum, chrome, or nickel. In the case of vacuum-coated second conductors 40, aluminum or silver provide very high reflectance and conductivity. The layer of conductive material can be patterned using well-known techniques such as photolithography, laser etching or by application through a mask.

In another embodiment, second conductors 40 can be formed by screen-printing a reflective and conductive formulation such as UVAG® 0010 from Allied Photochemical of Kimball, Mich. Such screen printable conductive materials comprise finely divided silver in an ultraviolet-curable resin. After printing, the material is exposed to ultraviolet radiation greater than 0.40 Joules/cm², the resin will polymerize in 2 seconds to form a durable surface. Screen-printing is preferred to minimize the cost of manufacturing the display. Alternatively, second conductors 40 can be formed by screen-printing a thermally cured silver-bearing resin. An example of such a material is Acheson Electrodag® 461SS, a heat cured silver ink. In the case that the dark layer 35 is black, any type of conductor can be used including black carbon in a binder.

Referring still to the embodiment of FIG. 1, a dielectric layer 50 made of substantially reflective non-conductive material can be provided over second conductors 40. Dielectric layer 50 is provided with “through via” 52 (shown clearly in FIGS. 11-13) that permit interconnection between second conductor 40 and conductive row contacts 54.

A dielectric layer, for purposes of the present invention, is a layer that is not conductive or blocks the flow of electricity. This dielectric material may include a UV curable, thermoplastic, screen printable material. The dielectric material may form an adhesive layer to subsequently bond a second electrode to the light modulating layer.

Substantially reflective, non-conductive materials or inks can be formed of compositions having high reflectivity in a binder. Titanium Dioxide has very high reflectivity and is useful in creating non-conductive high reflectivity surfaces. Pigments can be made from titanium dioxide by conventional grinding techniques to create domains in the 1 to 5 micron domain. The pigment can be mixed with a binder that hardens in the presence of heat or ultra-violet radiation. Pigments in a hardened bonder can be printed to create a no-conductive reflective layer in a given geometry. The reflectivity of a titanium dioxide binder can be significantly greater than the reflectivity of printed silver conductors. Other non-conducting inks exist which are substantially light absorbing, described as gray or black. U.S. Pat. No. 6,323,928 has no dark layer, and requires a dark electrode. In that invention, a substantially light-absorbing ink, Electrodag 423SS is used to create a dielectric layer that is substantially light absorbing using a binder having a low concentration of carbon to form a non-conductive dielectric layer. It has been found experimentally that small quantities of the dark dielectric can be mixed with quantities of the white dielectric to create a reflective surface that matches the reflectivity of printed second electrodes 40.

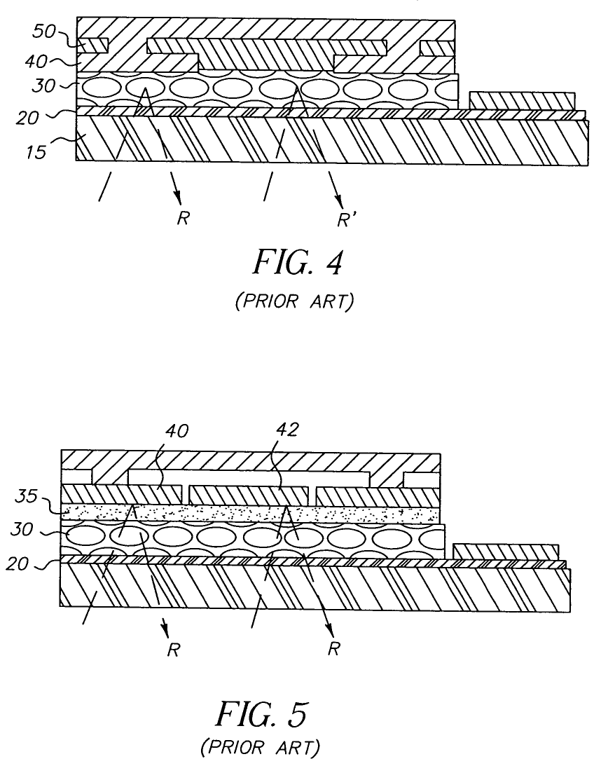

FIG. 4 is a side section view of a display made in accordance with first prior art. U.S. Pat. No. 6,394,870 to Petruchik et al discloses a dark conductive material, in one case carbon that provides an electrical field across cholesteric layer 30. The conductor must be dark to provide contrast when cholesteric layer 30 is electrically written into the focal-conic state. Because there is no dark layer 35, no complementary light is provided from reflective second conductors 40.

FIG. 5 is a side section view of a display made in accordance with commonly assigned unpublished second prior art. In accordance with copending U.S. patent application Ser. No. 10/672,799, filed Sep. 26, 2003, hereby incorporated by reference in its entirety, areas between second conductors 40 are filled with inter-segment material 42. In the copending application, inter-segment material is formed with electrically conductive material that provides essentially the same optical properties as the material used in second conductors 40. Inter-segment material 42 and the second conductors 40 provide a continuous reflectivity in all areas of the display. Gaps exist between second conductors 40 and the non-conductive conductive material that create optical discontinuities. It would be useful to prevent such discontinuities. The use of a reflective and electrically conductive inter-segment material is silver, which is expensive. The patent application further requires the application of an electric field to write inter-segment material into a fully planar state. The isolated conductive areas further render the display susceptible to long-term filed induced change of state in the inter-segment cholesteric material. It would be useful to provide material between segments having appropriate reflectivity and eliminate the electrical writing step.

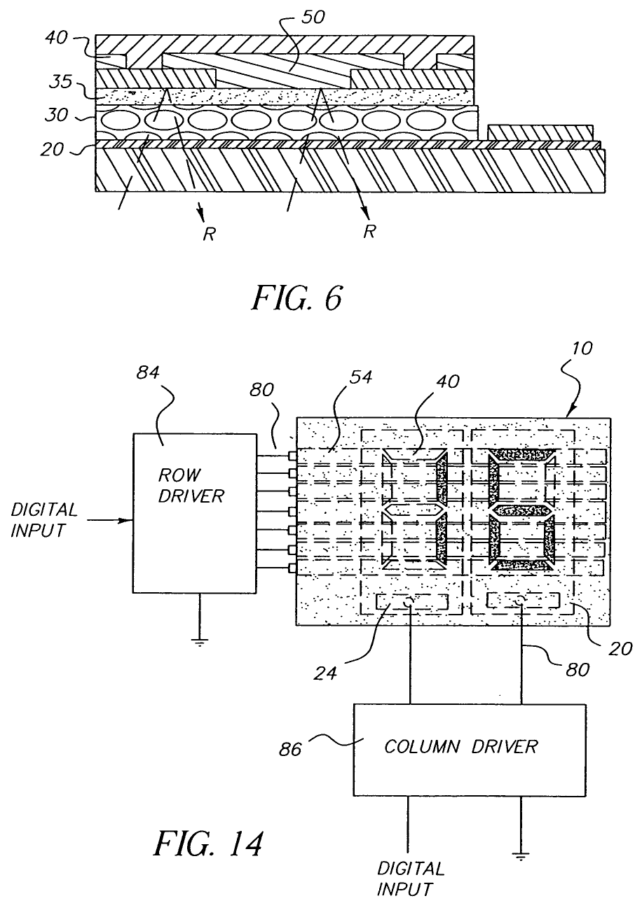

FIG. 6 is a side section view made in accordance with the present invention. Dielectric layer 50 formed of a reflective non-conductive material can be formed, for example, by printing or coating pigments in a binder polymer such as vinyl. A solvent can be added to provide a heat curable dielectric layer or a radiation sensitizing agent can be provided to create a radiation cured binder.

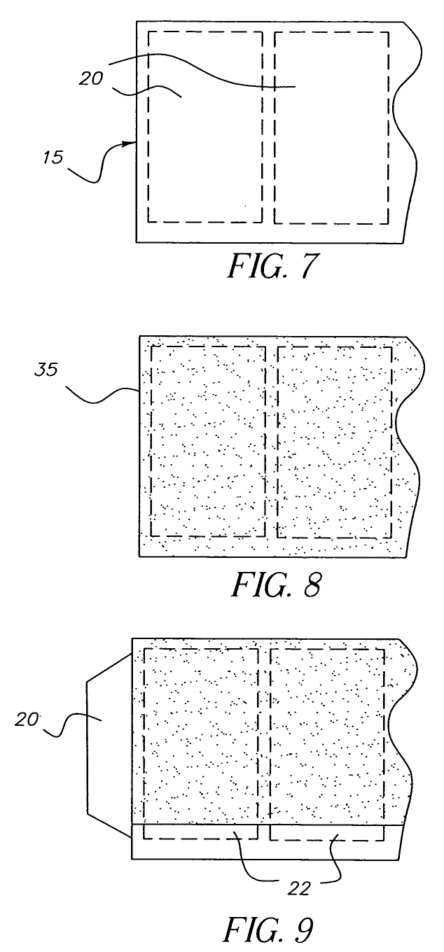

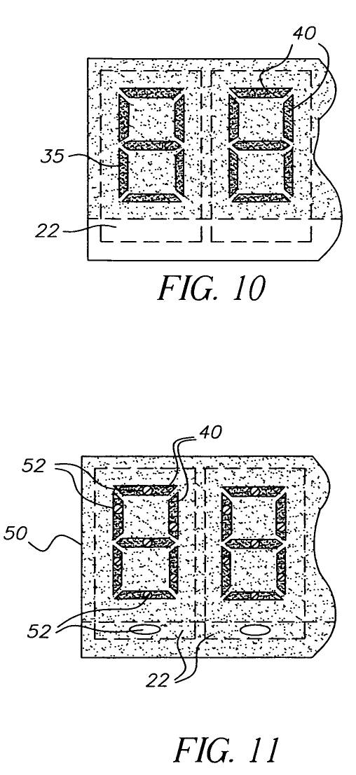

A process for fabricating display 10 will now be described. FIG. 7 is a rear view of a sheet in accordance with the present invention having a patterned first conductor. A substrate 15 is provided with a plurality of patterned first transparent conductors 20. FIG. 8 is a rear view of a sheet in accordance with the present invention having a polymer-dispersed cholesteric liquid-crystal layer 30 and a dark layer 35 (only dark layer 35 is viewable). In a preferred embodiment, cholesteric layer 30 and dark layer 35 are co-deposited. FIG. 9 is a rear view of a sheet in accordance with the present invention having exposed first conductors 22. Portions of cholesteric layer 30 and dark layer 35 can be removed, for example, using a solvent to form exposed first conductors 22. Alternatively, cholesteric layer 30 can be coated over only portions of transparent first conductors 20, leaving exposed first conductors 22. FIG. 10 is a rear view of a display having second conductors, which second conductors 40 have been printed over dark layer 35.

FIG. 11 is a rear view of a display in accordance with the present invention having an applied dielectric layer 50 of a substantially reflective non-conductive material. Dielectric layer 50 covers both second conductors 40 and inter-segment material 42 (shown in FIG. 5). Through via 52 permit access to second conductors 40. Design of multiple printed layers to create a matrix driven seven segment display having electrically writable inter-segment material are incorporated in co-pending U.S. patent application Ser. No. 10/426,539 by the same inventors, which application is hereby incorporated by reference in its entirety.

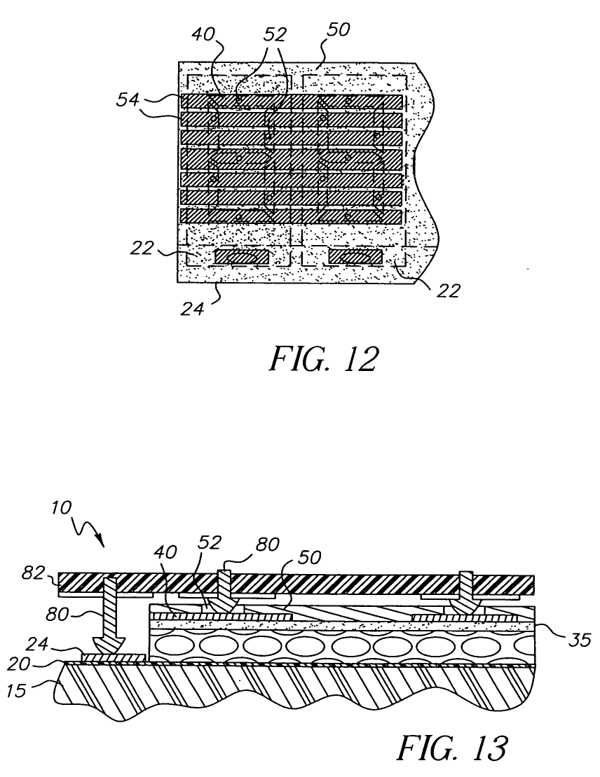

FIG. 12 is a rear view of a display (manufacturing intermediate) in accordance with the present invention having row contacts 54. Row contacts 54 are conductive traces printed to connect common second conductors using through via 52 in dielectric layer 50. Printing further portions of the same material used to create second conductors 40 over exposed first conductors 22 can provide protective covering 24 over exposed first conductor 22.

Row contacts 54 can be formed by screen printing the same screen-printable, electrically conductive material used to form second conductors 40. Row contacts 54 enable the connection of common segments in different characters, thereby creating functional rows of electrically addressable areas in the polymer-dispersed cholesteric liquid-crystal layer. The row contacts and exposed first conductors 22 form a set of backside display contacts that are used to electrically matrix address the display.

FIG. 13 is a sectional view of one embodiment of a display 10 comprising a substrate 15 and dark layer 35 in accordance with the present invention in which the display 10 comprises a circuit board attached to the assembly of FIG. 10. Contacts 80 on circuit board 82 provide electrical connection to each second conductor 40 and protective covering 24 over a first conductor in accordance with prior art, as will be understood by the skilled artisan. Instead of coating a dielectric layer 50, air may be used as a dielectric material in combination with suitable spacing achieved by contacts 80;

FIG. 14 is one embodiment of a completed display 10 in accordance with the present invention connected to an electric driver. Row driver 84 is connected by contacts 80 to row contacts 54. Column driver 86 is connected by contacts 80 to first transparent conductors 20 though protective covers 24. Electrical signals can be applied to row driver 84 and column driver 86 to write images onto display 10.

The use of: a flexible support for display substrate 15; thin first transparent conductors 20; machine-coated cholesteric liquid-crystal layer 30; and printed second conductors 40 permits the fabrication of a low-cost flexible display. Small displays according to the present invention can be used as electronically rewritable tags or labels for inexpensive, rewrite applications.

### EXAMPLE

An experiment was performed to create a non-conductive reflective layer that matched the reflectivity of the printed silver electrodes. Using two different color pigmented dielectric (UV curable) PTF inks from Allied Photo Chemical, inks were blended in a ratio such that the resultant color matches the color of the conductive UVAG 0010 silver ink. Using Allied TGH 1018WH (white pigmented dielectric ink), and TGH 7000GR (black pigmented dielectric ink), blended @ a ratio of 38.5:1 (respectively), the two inks were mixed together using a mechanical stirring method. The resultant ink was labeled 080403JK, and screen-printed using a DEK 248 screen printer. The blended dielectric material was screen printed in a pattern of a continuous sheet with the exception of via hole features, using a polyester screen mesh (Sefar America Pecap LE 7-305-34 low elongation polyester mesh). The screen mesh and gasketing screen emulsion resulted in a printed layer approximately 16 microns thick. A second identical patterned layer was then printed above the first (cured) layer to produce a total thickness stacked layer of dielectric ink that was ˜32 microns thick. Both dielectric printed layers were independently cured using UV lamp exposure of <400 nm wavelength @>0.2 mj/cm², utilizing a Fusion UV cure unit and belt conveyor to pass the printed substrate through the UV cure chamber. Printing of two identical patterned dielectric layers is a best practice in the screen-printing art to produce a dielectric layer that is pinhole defect free.

The resulting displays had continuous optical properties in areas written by second electrodes 40 and by dielectric 50. Additional adjustments can be made to adjust reflectivity of dielectric to adjust complementary light 64 to compensate for cholesteric material in the near-planar, or as-coated, optical state.

The invention has been described in detail with particular reference to certain preferred embodiments thereof, but it will be understood that variations and modifications can be effected within the spirit and scope of the invention.

1. A display element comprising in order:
a) a substrate;
b) transparent first conductors;
c) a light-modulating material disposed over the first transparent conductors and having different first and second field-changeable stable optical states, a transmissive and a reflective state;
d) a light-absorbing layer, over the light-modulating material, that absorbs a portion of the visible spectrum and transmits another portion of the visible spectrum;
e) substantially reflective second conductors forming conductive segments, over a plurality of segmented areas of the light-absorbing layer, that operate in conjunction with the light-absorbing layer to provide reflective light additional to that provided by the light-modulating material;
f) substantially reflective non-conductive inter-segment material, disposed over one or more background areas of light-absorbing layer not covered by second conductors, to provide reflective light additional to that provided by the light-modulating material such that total reflected light in background areas more closely match total reflected light in the segmented areas when both areas are in the same optical state.

2. The display element of claim 1 wherein reflectivity of the second conductors and reflectivity of the substantially reflective non-conductive inter-segment material are substantially equivalent.

3. The display element of claim 2 wherein the reflectivity of the non-conductive inter-segment material is greater than that of the second conductors.

4. The display element of claim 3 wherein the reflectivity of the non-conductive inter-segment material is greater than that of the second conductors to substantially compensate for lower reflectivity of as-coated light-modulating material in the background areas, as compared to higher reflectivity of electrically induced reflective state in changeable display areas.

5. The display element of claim 1 such that the substantially reflective second conductors and the substantially reflective non-conductive inter-segment material provide, in conjunction with the overlying layers, substantially equivalent optical appearances for corresponding display areas when in the same optical state.

6. The display element of claim 1 comprising a display area capable of forming a display comprising one or more alpha-numeric characters in a character region, wherein the substantially reflective non-conductive inter-segment material provides an inter-segment background element, corresponding to a patterned background region in the character region, said inter-segment background element and said second conductors forming upper planar surfaces that are substantially level in a plane parallel to a mid-plane of the display element, and wherein, in said plane, the inter-segment background element is disposed substantially outside the peripheral boundary of the second conductors.

7. The display element of claim 4 wherein the light-modulating material is a cholesteric material in which the reflective state is a planar state and said as-coated material is in a near-planar state having less reflectivity than the electrically induced reflective state.

8. The display element of claim 6 further comprising third conductors, in a lower layer, connected to second conductors, in more than one character region.

9. The display element of claim 1 wherein the light-modulating material comprises polymer-dispersed cholesteric liquid-crystal material with a peak reflected wavelength between 570 and 590 nanometers.

10. The display element of claim 1 wherein the light-absorbing layer comprises sub-micrometer pigment particles in a polymeric binder.

11. The display element of claim 1 wherein the substantially reflective second conductors are formed of printed silver ink.

12. The display element of claim 1 wherein the substantially reflective second conductors are formed of vacuum deposited metal.

13. The display element of claim 1 wherein the light-modulating material forms an imaging layer and comprises polymer-dispersed cholesteric liquid-crystal material that transmits light in a focal-conic state and reflects light in a planar state to provide a liquid-crystal-derived reflected light reaching an observer.

14. The display element of claim 13 wherein the light-absorbing layer has a light absorbance such that, when the liquid-crystal material is in the planar state, the total reflected light reaching the observer, comprising both liquid-crystal-derived reflected light and color-filtered reflected light from the substantially reflective second conductors and/or the substantially reflective non-conductive material is substantially more neutral than the liquid-crystal-derived light alone without the color-filtered reflective light.

15. The display element of claim 14 wherein the color-filtered reflected light is substantially complementary to the liquid-crystal-derived first reflected light, thereby providing a total reflected light reaching the observer that is substantially neutral when the liquid-crystal material is in the planar state.

16. The display element of claim 1 wherein the substantially reflective second conductors and substantially reflective non-conductive material both reflect at least 50% of the light reaching their surface.

17. The display element of claim 1 wherein the first conductors and the second conductors are patterned to produce an addressable matrix.

18. The display element of claim 1 wherein the light-modulating material forms an imaging layer that comprises a cholesteric liquid-crystal material dispersed in a matrix comprising gelatin.

19. The display element of claim 1 wherein the second conductors are opaque printed conductors.

20. The display element of claim 1 wherein the inter-segment material and second conductors are both vacuum deposited.

21. The display element of claim 1 wherein the light-modulating material comprises liquid-crystals.

22. The display element of claim 21 wherein the first field-changeable stable optical state is a reflective state and the liquid-crystal is essentially in a planar orientation.

23. The display element of claim 22 wherein the liquid-crystal background areas are in a field-induced planar orientation providing a reflective state adapted to contrast with a display image in a relatively dark transmissive state.

24. The display element of claim 1 wherein the light-modulating material comprises polymer-dispersed domains of cholesteric liquid-crystal.

25. The display element of claim 1 wherein between the first and the second field-changeable stable optical states, the display is capable of providing a gray scale.

26. The display element of claim 1 wherein the non-conductive inter-segment material is in contact with the second conductors.

27. The display element of claim 1 further including:
a) a dielectric layer having a through via to each second conductor; and
b) conductive traces over the dielectric layer to interconnect selected second conductors, whereby the display may be addressed in a matrix fashion by electrically addressing a first and second set of contacts.

28. The display element of claim 1 further comprising a display driver and a display area capable of displaying a plurality of characters, each character having a character region and a background region, wherein each character region comprises a plurality of segments, wherein each character region corresponds to at least one of the first conductors, the second conductors are patterned to have electrically separate areas corresponding to segments of the character region, and wherein the inter-segment material forms an inter-segment background element, corresponding to the background region, comprising patterned areas in a character region, said background region and the second conductors having upper surfaces covering different areas of the light-modulating material.

29. The display element of claim 30 further comprising third conductors connected to the second conductors in more than one character region.

30. he display element of claim 1 in which the light-modulating material forms at least one imaging layer disposed between the first and the second conductors, which material is capable of having a first and a second field-switchable stable optical state which states correspond, respectively, to a first and a second contrasting optically visible state, and which material has a further property, when coated on a substrate and before application of an electromagnetic field, of exhibiting an as-coated optical appearance that is near to a first visible state and, after being subjected to a field of exhibiting a field-induced optical appearance.

31. The display element of claim 1 having a display area capable of displaying a plurality of characters in a background, the characters including a plurality of segments corresponding to the second conductors in a second-conductor layer located over the layer of light modulating material and forming electrically separate patterned areas defining the segments of the characters.

32. The display element of claim 31 further comprising a dielectric layer located over the second conductor layer, the dielectric layer defining holes over at least each segment of the second conductor layer, the display further comprising a patterned third conductor layer defining a plurality of third conductors connected to the areas defining the character segments in the second conductor layer; at least one of the third conductors being connected to a segment in more than one character; and whereby the display may be addressed in a matrix fashion by electrically addressing, via electrical contact with the third conductors in the third conductor layer, the first and the second conductors.

33. The display of claim 1, wherein the light-modulating material comprises domains of chiral-nematic liquid crystal dispersed in a polymer matrix.

34. A method of making a display having a display area capable of displaying a plurality of characters in a background, the characters including a plurality of segments, comprising the steps of:
a) providing a substrate;
b) forming a first patterned conductor layer on the substrate having electrically separate areas defining character regions;
c) forming a layer of light-modulating material over the first patterned conductor layer;
d) forming a light-absorbing layer, over the light-modulating material, that absorbs a portion of the visible spectrum and transmits another portion of the visible spectrum;
e) forming a patterned second conductor layer, having a substantially reflective upper surface, over the layer of light modulating material and having electrically separate areas defining segments of the characters and the background;
f) forming inter-segment background of substantially reflective non-conductive material and having an upper surface that is in substantially the same plane as the substantially reflective upper surface of the patterned second conductor layer over the layer of light modulating material and having areas defining the background in peripheral contact with the segments second patterned;
g) optionally applying a dielectric layer over the patterned second conductor layer, the dielectric layer defining holes over each segment; and
h) forming a third patterned conductor layer defining a plurality of third conductors connected to the areas defining the character segments in the patterned second conductor layer; at least one of the third conductors being connected to a segment in more than one character, whereby the display may be addressed in a matrix fashion by electrically addressing the first and the second patterned conductors; and
i) connecting the display to a driver capable of addressing the display in a matrix fashion by electrically addressing, via electrical contact with the conductors in the third patterned conductor layer, the patterned first and the second-conductor layers.
